(19) United States
(12) Patent Application Publication
(10) Pub. No.: US 2023/0376650 A1
(43) Pub. Date: Nov. 23, 2023

(54) METHOD AND SYSTEM FOR OPTIMIZING DEVICE SHAPE

(71) Applicant: The Board of Trustees of the Leland Stanford Junior University, Stanford, CA (US)

(72) Inventors: Lambertus Hesselink, Atherton, CA (US); Lars Thorben Neustock, Menlo Part, CA (US)

(21) Appl. No.: 18/199,755

(22) Filed: May 19, 2023

Related U.S. Application Data
(60) Provisional application No. 63/344,009, filed on May 19, 2022.

(51) Int. Cl. G06F 30/23; G06F 30/10

(52) U.S. Cl. CPC G06F 30/23; G06F 30/10

(57) ABSTRACT

A method includes receiving/processing a device geometry data for a device based on a boundary element method (BEM) to generate a surface physics solution and further to generate a first intermediate data; applying additional underlying physics rule to the generated surface solution and generating a second intermediate data; evaluating performance of the device based on the applying; generating a gradient between the evaluated performance of the device and a desired performance; storing the intermediate data in a memory component; applying the additional underlying physics rule to the generated gradient and to the second intermediate data to generate a gradient of the parameters of the physics rules; processing the gradient of the parameters of the physics rules based on the BEM and the first intermediate data to generate a gradient of the generated surface solution; and updating the device geometry data based on the gradient of the generated surface boundary.

### RELATED APPLICATIONS

The instant application claims the benefit and priority to the U.S. Provisional Application No. 63/344,009, filed on May 19, 2022, which is incorporated herein by reference in its entirety.

### BACKGROUND

Device shape (i.e., physical attributes) generally affects the operation of the device depending on the application. For example, the shape of electron lenses affect their functionality and performance. Similarly, the shape of a spectrometer impacts the way it functions. As another example, in trapped-ion quantum computing, the device shape affects the quality of ion traps and therefore its functionality, scalability and performance.

Regardless of the application, it is desirable to optimize the device shape to improve performance. Engineers and designers are often required to manually vary the shape (e.g., geometric shapes and design parameters) of the device and run simulation time after time to evaluate the new design in order to search for an optimized shape. Unfortunately, varying the shape of the device manually and running simulation iteratively, is not only manual in nature but also computationally burdensome and often times incapable of any meaningful optimization for complex device with complex geometric shapes.

In certain technological fields such as aerodynamics, differentiated physics solvers have been used to optimize the device shape. In electromagnetic related technological applications, such as photonics and microwave technologies, differentiated physics solvers based on core physics algorithms have been used, e.g., finite-difference time-domain (FDTD), finite-element method (FEM), finite difference method (FDM), etc. Unfortunately, the conventional approach utilizing differentiated physics solvers (as described above, e.g., FEM, FDM, etc.) in charged particle optics and trapped ion quantum computing, as an example, do not result in highly-accurate gradients that are needed for successful optimization of the device shape.

In some conventional methods, a differentiated boundary element method (BEM) algorithm has been used to optimize certain types of devices, e.g., high voltage devices, based on spline-based implementation. Unfortunately, the spline-based implementation is incompatible with mesh-based design. Accordingly, some conventional methods have used other methodologies to handle the mesh-based design but unfortunately those conventional methods fail to fulfill the requirements of a fine-grained optimization.

### SUMMARY

Accordingly, a need has arisen to efficiently and effectively optimize the shape of a device based on its physical functionality (and/or desired functionality).

According to some embodiments, a forward system and a reverse system may be used. The forward system may include a model characterizing the device features according to appropriate physical rules. The model may be comprised of a boundary element method (BEM) for partial differential equations, e.g., Laplace, Maxwell, Helmholtz, etc., and other numerical approaches for physical equations, e.g., the Verlet Integration Method to solve the nonlinear system of Newton's and Coulomb's law in conjunction. These equations govern the behavior of the device and their specific solution is dependent on the device shape. The forward system may also receive a desired performance (and/or manner to determine performance to evaluate the actual performance). The forward system also assists with the generation of a gradient associated with the device (i.e., differentiation of the function describing the desired performance of the device and evaluates how close the desired performance is to the actual performance, with respect to the device design parameters). It is appreciated that the intermediate data generated by the forward system and the resulting performance evaluation by the forward system may be stored for use by the reverse system, at a later stage.

The performance evaluation generated by the forward system in differentiated form (i.e., difference between the desired performance and the actual performance) and the intermediate data (that were previously stored) are fed into the reverse system (i.e., calculation of the performance evaluation first, then other physical equations followed by differentiated BEM) to calculate each step's derivative. Accordingly, the reverse system calculates the manner by which the device shape (e.g., 2D or 3D shape) or other device attributes such as an applied voltage has to change in order to achieve the desired performance. The computation performed by the reverse system may be referred to as adjoint variable method or automatic differentiation. The output of the reverse system includes the gradient of the device design to any desired design parameters at the same step in the computation, e.g., location of mesh vertices, radii, distances, spatial coordinates, applied voltages etc., associated with the device. It is appreciated that this process may be repeated a number of times (i.e., iteration) in an automated fashion to optimize the device shape.

These and other features and aspects of the concepts described herein may be better understood with reference to the following drawings, description, and appended claims.

### BRIEF DESCRIPTION OF DRAWINGS

FIG. 1 depicts a system configured to optimize a device shape according to some embodiments.

FIG. 2A depicts a system configured to optimize a device shape including a mesh smoothing process according to some embodiments.

FIG. 2B depicts a system configured to update one or more device shape parameters based on the optimized device shape according to some embodiments.

FIGS. 3A-3E depict simulation results for optimizing a device shape for various applications according to some embodiments.

FIG. 4A is a flow chart illustrating an example method flow for optimizing a device shape (mesh vertices), as described in FIGS. 1-2A, in accordance with some embodiments.

FIG. 4B is a flow chart illustrating an example method flow for optimizing a device shape one or more device shape parameters, as described in FIG. 2B, in accordance with some embodiments.

FIG. 5 is a block diagram depicting an example of a computer system suitable for optimizing a device shape in accordance with some embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

It should also be understood that the terminology used herein is for the purpose of describing concepts and not intended to be limiting. Unless defined otherwise, all technical and scientific terms used herein have the same meaning as commonly understood by those skilled in the art to which the embodiment pertains.

It is appreciated that the embodiments are described for applications such as charge-particle devices, trapped ion quantum computing, etc., for illustrative purposes and should not be construed as limiting the scope of the embodiments. To the contrary the embodiments may be equally applicable to any other applications such as radar system (e.g., Maxwell application), Helmholtz problem to increase/decrease field as an example, etc.

According to some embodiments, in optimizing a device shape, a forward system and a reverse system may be used. The forward system may include a model (comprising boundary element method (BEM) characterizing the physical behavior (governed by appropriate physical rules, e.g., electrostatic field, electromagnetic field, etc.) of the device according to its shape, followed by appropriate additional physical rules, e.g., Verlet integration, etc., governing the device and application (e.g., charged-particle, etc.) determining the impact of the device shape on its functionality/performance. It is appreciated that BEM receives one or more equations, e.g., governing physics, and solves the partial differential equation for that device shape being governed by those equations. As such, BEM is applied to the geometry of the device (e.g., mesh) and reduces a space problem to a surface problem. In certain applications, e.g., charged-particle application, BEM may not provide a complete solution to the application. For example, while BEM may provide a partial solution for electrostatic field on the surface of the device it may not provide any insight into how that electrostatic field may affect a trajectory of a charged-particle traveling through the device or within a vicinity of the device. Additional physics equations, e.g., governing physics, may further be applied to BEM to provide a complete solution. For example, it is appreciated that Verlet Integration referred to herein is a numerical method to integrate Newton's equations of motion that may be used to calculate trajectories of particles in molecular dynamics simulations and computer graphics as an example.

The forward system may also receive a desired performance (and/or manner to determine performance) to generate a performance evaluation of the device. It is appreciated that the desired performance for the device may be compared to the actual performance based on actual set of device parameters that determine the device geometry. It is appreciated that the intermediate data generated by the forward system may be stored for use by the reverse system, at a later stage.

The performance evaluation and the intermediate data are fed into the reverse system (i.e., physical rules first followed by BEM) to calculate each step's derivative. Accordingly, the reverse system calculates the manner by which the device shape (e.g., physical shape) has to change in order to achieve the desired performance. The reverse system may be referred to as adjoint variable method or automatic differentiation. The output of the reverse system includes parameters, e.g., location of mesh vertices, etc., associated with the device.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the detailed descriptions that follow are presented in terms of procedures, methods, flows, logic blocks, processing, and other symbolic representations of operations performed on a computing device or a server. These descriptions are the means used by those skilled in the art to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical, optical or magnetic signals capable of being stored, transferred, combined, compared, and otherwise manipulated in a computer system or computing device or a processor. These signals are sometimes referred to as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “analyzing,” “transmitting,” “facilitating,” “providing,” “forming,” “detecting,” “processing,” “updating,” “instantiating,” “identifying,” “calculating,” “computing,” “accessing,” “utilizing,” “resolving,” “applying,” “displaying,” “rendering,” “aggregating,” “associating,” “requesting,” “monitoring,” “changing,” “updating,” “evaluating,” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, a hard drive, etc. Example embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, solid state drives, hard drives, hybrid drive, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

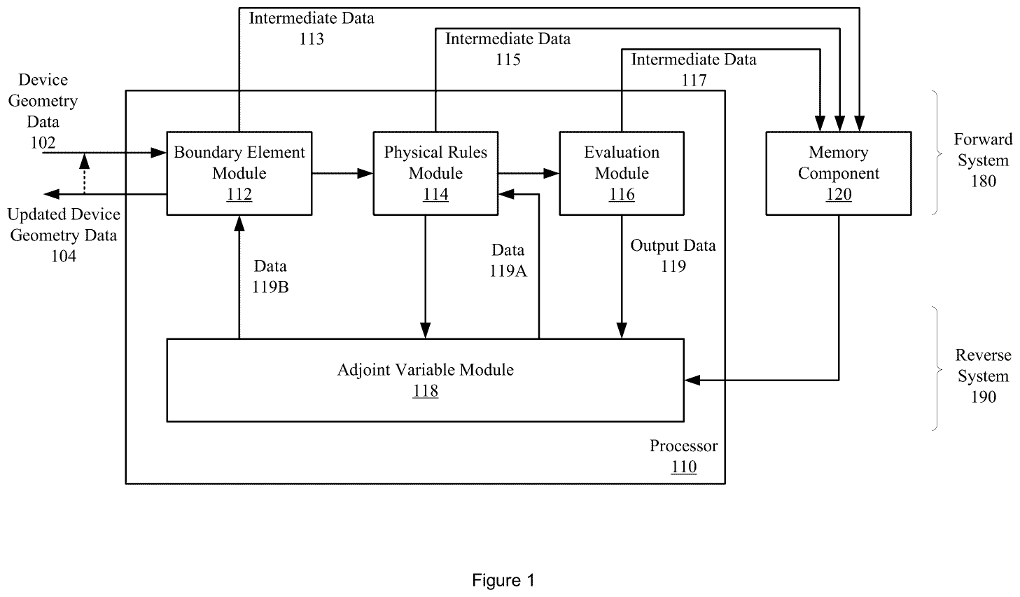

Referring now to FIG. 1, a system configured to optimize a device shape according to some embodiments is shown. The system may include a forward system 180 (data is processed in the forward order) and a reverse system 190 (data is processed in the reverse order of the forward system 180).

Although the diagrams depict components as functionally separate, for determining the importance of the electronic message to the sender such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks. Each of the engines is a dedicated hardware block/component including one or more microprocessors and on-chip memory units storing software instructions programmed by a user for various operations, e.g., content analysis, sender/recipient relationship analyzer, priority analyzer, machine learning operations, etc. When the software instructions are executed by the microprocessors, each of the hardware components becomes a special purposed hardware component for practicing certain operations including machine learning functions as discussed in detail below. In some embodiments, the architecture is on a single chip, e.g., a system-on-chip (SOC).

The system may include a processor 110 that may be used to process data such as device shape to determine its performance and manner by which the device shape is to be changed to optimize the device's operation/functionality. The processor may include a central processing unit (CPU), an application specific integrated circuit (ASIC), a field programmable gate array (FPGA), a microcontroller, a graphics pipeline unit (GPU), etc. The processor may include various processing modules that may be integrated within the processor 110 or communicatively coupled thereto. In some nonlimiting examples, the processor 110 may include a boundary element module (also referred to as BEM module) 112, a physical rules module 114, and an evaluation module 116. The processor may be coupled to a memory component 120, e.g., read access memory (RAM), a hard drive, a solid-state drive, a flash drive, etc., to store intermediate data being generated by each of the processing modules. The reverse system 190 may include an adjoint variable module 118. The functionality and operation of each processing module is described in greater detail below.

It is appreciated that the BEM module 112 is configured to receive the device geometry data 102. The device geometry data 102 may be a system generated data that describes the device shape, or it may be a user-defined initial geometry for the device (and received using a user input device such as a mouse or keyboard). In some nonlimiting examples, the device geometry data 102 may be in a triangular mesh format. It is appreciated that the BEM module 112 is configured to characterize the physical behavior of the device in a given application governed by appropriate physical rules and to reduce the space problem associated with the device shape to a surface problem. For example, in an electrostatic field application, the BEM module 112 characterizes the physical behavior of the device by computing the electrostatic field at any point in space. In one nonlimiting example, a partial differential equation of a Laplace type (or Maxwell or Helmholtz) in the form of an integral equation may be solved and processed by the BEM module 112 to characterize the physical behavior of the device governed by electrostatic field (or electromagnetic waves or general wave phenomena). It is appreciated that in one nonlimiting example the integral equation derived with Greens function may be the solution to the partial differential equation. The BEM module 112 is configured to solve (i.e., process) the integral on the surface of the device geometry (i.e., device geometry data 102) that is subject to additional boundary conditions. In one example, the integral equation may be defined and processed for several surface points of the mesh elements (defining the device shape as received by the device geometry data 102), thereby reducing the space problem to a surface problem. Accordingly, the BEM module 112 may process the device geometry data 102 that is subsequently used to determine the manner in which the geometry of the device (surface boundary) impacts the space around it. It is appreciated that while in some applications, e.g., electrostatic field, the BEM module 112 may compute a complete solution in other applications, e.g., a charged particle traveling through the device, the BEM module 112 may only provide a partial solution. For example, additional processing may be needed to determine the trajectory of a charged particle as it travels through the electrostatic field of the device. This additional processing is performed by the physical rules module 114 that is described in greater detail below. It is appreciated that the output of the data generated by the BEM module 112 is input to the physical rules module 114 for further computation if needed, e.g., charged particle application. Moreover, it is appreciated that intermediate data 113 generated by the BEM module 112 may be stored in the memory component 120 to be subsequently used by the reverse system 190 at a later stage. Examples of the intermediate data 113 includes surface data for physical quantities and their derivative, matrix elements for linear system solving, integral data for non-singular points, integral data for singular points, etc.

The physical rules module 114 may access one or more rules associated with the application (i.e., underlying physics equation for the application that are not sufficiently solved by the BEM module 112) to evaluate and compute the physical behavior of the device based on the device shape. For example, rules may be associated with Verlet integration for charged particles. It is appreciated that the rules associated with the application may be user provided, e.g., via a mouse/keyboard, voice command, touch screen, etc., or it may have been stored in a memory component and fetched based on a user selection (which may be based on the application). It is appreciated that the physical quantities defined by the geometry of the device as determined by the BEM module 112 and the rules as determined by the physical rules module 114 form a full model of the physical behavior of the device. For illustration purposes, charged particles are used as an example for a particular technology and application. As such, the Verlet integration may be used by the physical rules module 114 to process and determine the manner by which a charged particle travels through the device, given the initial condition of the charged particle, the medium, and the electrostatic field resulting from the device shape as processed and determined by the BEM module 112. It is appreciated that the physical rules module 114 outputs its results to the evaluation module 116. Moreover, it is appreciated that intermediate data 115 generated by the physical rules module 114 may be stored in the memory component 120 to be subsequently used by the reverse system 190 at a later stage. Examples of the intermediate data 115 includes acceleration data at different time steps, position data at different time steps, speed data at different time steps and interpolation coefficients for various spatial points and time steps.

The evaluation module 116 may be configured to access one or more rules/parameters (e.g., as a function) that can be used to compute the performance of the system (e.g., determining the electromagnetic field, determining electromagnetic field intensity, etc.) and/or identifies the objective of the system (e.g., having a certain electromagnetic field value, having a particular electromagnetic field intensity, etc.). It is appreciated that the rules/parameters used by the evaluation module 116 to evaluate performance of the device and/or determine the objective (e.g., expected/ideal performance) of the device may be user defined (e.g., received from the user) or may be system generated. For example, the user may input the desired performance (e.g., desired electromagnetic field as an example) as well as the manner by which the performance (e.g., electromagnetic field) is computed and measured.

The evaluation module 116 may process the received data and/or rules to compute the performance of the device based on the device shape. The evaluation module 116 may then compare the computed performance based on the device shape to the ideal (or desired) performance and determine the derivative of the ideal (or desired) performance and output the result as output data 119. It is appreciated that the output of the evaluation module 116 reflect changed to the device's behavior that need to be made in order to optimize the device. However, since the system as whole is governed by complex physics equations, e.g., charged particles, the output of the evaluation module 116 does not necessarily translate to a more optimized device shape. As such, the output of the evaluation module 116 is fed into the reverse system 190, as described in greater detail below to optimize the device shape by taking the complexity of the system into consideration. It is appreciated that intermediate data 117 generated by the evaluation module 116 during its computation may be stored in the memory component 120 to be subsequently used by the reverse system 190 at a later stage. Examples of the intermediate data 117 includes numerical values that define the desired behavior of the device and how deviation from this behavior are numerically penalized.

It is appreciated that storing of the intermediate data within the same memory component is for illustrative purposes only and should not be construed as limiting the scope of the embodiments. For example, the intermediate data from various processing modules may be stored in different memory components, if desired.

It is appreciated that the output data 119 is output from the evaluation module 116 and may be fed into the reverse system 190 to compute the differences between each of the intermediate parameters (previously stored in the memory component 120). In other words, the computation is being performed in the reversed order to ultimately compute the differences/changes to be made to the initial device shape in order to achieve the desired performance. In other words, the gradient of the system, e.g., list of values that describes how the device performance changes if one or more design parameters change, vectors of all derivatives of desired performance with respect to the design parameters, etc., with respect to the design parameters, e.g., location of mesh vertices, surface points, radii, lengths, distances, etc., is computed by the reverse system 190. Using the above described system, devices with different shapes and for different applications subject to different physical rules and constraints may be optimized in an automatic and efficient manner.

In the reverse system 190, computation is performed in reverse order of the forward system 180 in order to calculate each module's (step's) derivatives. The reverse system 190 may include adjoint variable module 118 that receives the intermediate data 113, 115, and 117 from the memory component 120. Moreover, the adjoint variable module 118 receives the output data 119 from the evaluation module 116 or from a memory component (if stored in one). The adjoint variable module 118 is configured to use the intermediate data 113, 115, and 117 along with the output data 119 to compute the gradient of the system for the outputs of each processing module, e.g., physical rules module 114, BEM module 112, etc. In one nonlimiting example, the adjoint variable module 118 transmits data 119A associated with intermediate data 117 and 115 to the physical rules module 114. The physical rules module 114 also receives the output data 119 (e.g., from the evaluation module 116 or the adjoint variable module 118). Accordingly, the physical rules module 114 computes the desired changes of the propagation of the charged particles backward in the device and turns them into desired changes in the electrostatic field. The physical rules module 114 then provides the results to the adjoint variable module 118, which computes the system gradient (i.e., values describing how to change the design parameters based on actual device shape and the desired performance), which is provided as data 119B to the BEM module 112 for further processing. In some embodiments, the physical rules module 114 may also output its results in a reverse order to the BEM module 112. The BEM module 112 also receives data 119B from the adjoint variable module 118 that may include the intermediate data 113 and the system gradient result as computed on the output of the physical rules module 114. As such, the BEM module 112 may process and compute the gradient (i.e., difference between the device parameters such as mesh vertices to the desired performance or a list of derivatives). The BEM module 112 outputs the updated device geometry data 104, e.g., new mesh vertices, which provides the direction in which the device shape ought to be changed to improve performance based on the desired performance, as indicated earlier. The updated device geometry data 104 may be used as changes to be made to the original device shape (e.g., changes to the mesh vertices) in order to improve the device performance. It is appreciated that this process may be repeated for a number of iterations in order to achieve an optimized device shape.

It is appreciated that the adjoint variable module 118 is shown as a separate module for illustration purposes only and should not be construed as limiting the scope of the embodiments. For example, the evaluation module 116 may alternatively output data 119 to the physical rules module 114 and the physical rules module 114 may also receive the intermediate data 115 and 117 from the memory component 120 to perform its computations in the reverse order. Then the physical rules module 114 may output its result to the BEM module 112 that also receives the intermediate data 113 from the memory component 120 to perform its computation, as described above. It is noteworthy that depending on the application, the physical rules module 114 that performs additional processing depending on the application may be skipped if the BEM module 112 provides a full solution for the application itself, e.g., electrostatic field application, whereas the physical rules module 114 may not be skipped if the BEM module 112 provides a partial solution for an application, e.g., charged particles.

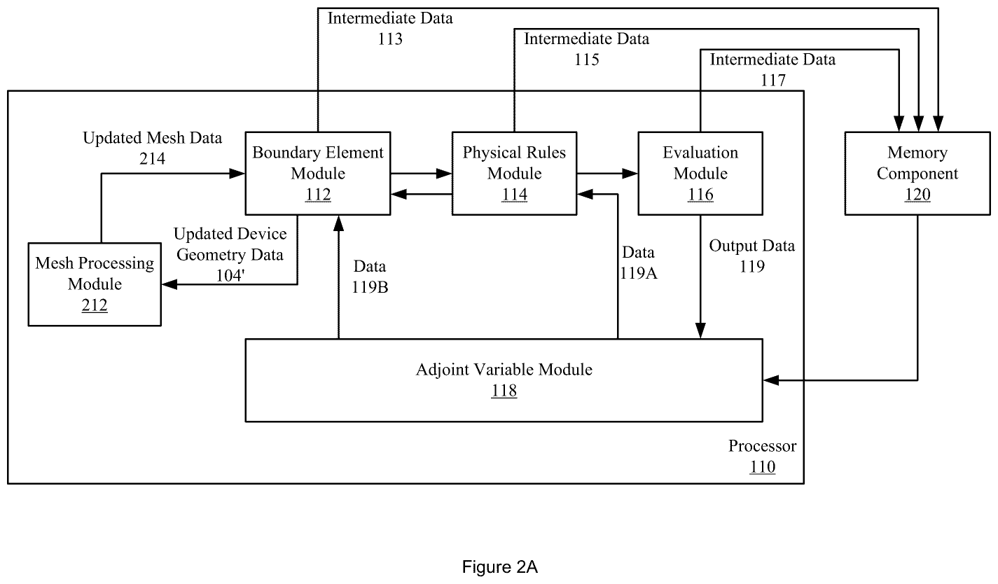

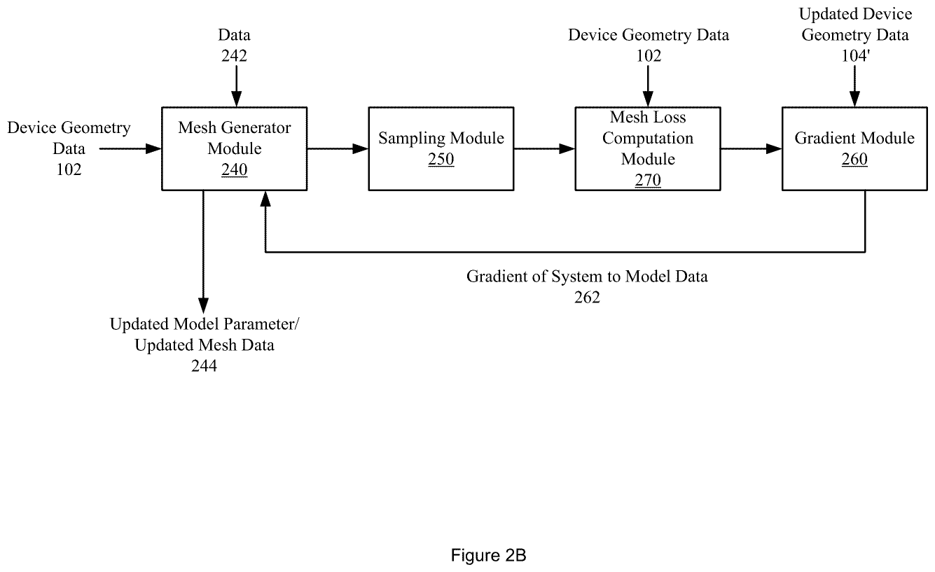

It is appreciated that as gradient provides a derivative for each mesh vertex, each vertex may be updated using gradient descent, as an example, which may lead to locally distorted mesh. Locally distorted mesh may pose difficulties for certain applications with certain underlying physics rules, e.g., poor accuracy, sharp edges for the device shape that may be difficult to manufacture, etc. Accordingly, a mesh processing operations may be introduced, as shown in FIG. 2A, to overcome some of the aforementioned challenges.

Referring now to FIG. 2A, a system configured to optimize a device shape including a mesh processing according to some embodiments is shown. FIG. 2A is substantially similar to that of FIG. 1. In this nonlimiting example, the output of the BEM module 112 in the reverse system is updated device geometry data 104′. It is appreciated that updated device geometry 104′ may be fed back into the forward system 180 to repeat the process a number of times (iterations). After a number of iterations, e.g., 5 iterations, 8 iterations, etc., the output of the BEM module 112 which is the updated device geometry data 104′ may be sent to the mesh processing module 212 for further processing (e.g., smoothing operation) in order to further improve various metrics of the device shape, e.g., minimum angle, etc. The mesh processing module 212 may apply further constraints on the mesh vertices, e.g., by computing mesh quality, by computing the length of the mesh edge (referred to as mesh edge loss), by computing smoothness of the mesh (e.g., using Laplacian smoothing), consistency of the direction of neighboring mesh element normal vectors (e.g., mesh normal consistency), distance between mesh edges (mesh edge distance), etc.

In other words, the mesh smoothing operation may be performed to improve practical manufacturing of the device shape, to ensure that the optimization routine does not favor an overly extreme solution, and to ensure that the computations continue to be accurate. It is appreciated that in some embodiments, the mesh smoothing operation may be performed after each iteration or in some embodiments it may be performed after a certain number of iterations (which may be user selectable). Once the mesh processing module 212 processes the updated device geometry data 104′, the updated mesh data 214 may be generated that may ultimately be used as parameters and dimensions associated with the device shape for manufacturing the device. It is appreciated that a mesh smoothing operation is described for illustrative purposes and should not be construed as limiting the scope of the embodiments. For example, a regularization may be used to prevent a mesh vertex from laying beyond a specific line or plane. In other words, operations such as regularization may be used to reduce the adjusted loss function and to prevent overfitting or under-fitting, as an example. It is appreciated that mesh smoothing operation and/or regularization may be used together or separate from one another, as desired.

It is appreciated that the embodiments described above update the entire mesh, which may be impractical from the manufacturability purposes. In some embodiments, one or more specific parameters of the device shape, e.g., radius, length, width, height, etc., may be selected to be changed in order to optimize the device shape instead of updating the entire mesh, as described in FIG. 2B.

Referring now to FIG. 2B, a system configured to update one or more parameters of the device shape parameters, including parameters defining the mesh itself, given the updated mesh, as determined by embodiments of FIGS. 1 and 2A, according to some embodiments is shown. It is appreciated that the modules illustrated are processing modules within a processor (similar to that described in FIG. 1) and that the modules are shown as separate module for illustration purposes only and should not be construed as limiting the scope of the embodiments. The system of FIG. 2B includes a mesh generator module 240, a sampling module 250, a gradient module 260, and a mesh loss computation module 270. It is appreciated that the mesh generator module 240, the sampling module 250, the mesh loss computation module 270, and the gradient module 260 of FIG. 2B replace the mesh processing module 212 of FIG. 2A.

The mesh generator module 240 is configured to receive data 242. Data 242 may include one or more parameters that defines the device shape. For example, the data 242 may include a parameter that defines the position of the device shape's center or it may be the radius of the device shape (if spherical). It is appreciated that the data 242 may be a slightly varied version of the actual parameter of the device shape. It is appreciated that data 242 may be either received, e.g., from a user, or it may be computed automatically once the device geometry data 102 is received. As such, the mesh generator module 240 may optionally be configured to receive the device geometry data 102, similar to that described in FIG. 1. The mesh generator module 240 generates a mesh associated with the device shape based on data 242.

The mesh generated by the mesh generator module 240 is input to the sampling module 250 in order to sample the mesh to calculate a cloud of points that lie on the mesh. The sampled point cloud is output from the sampling module 250 to the mesh loss computation module 270. The mesh loss computation module 270 may also receive the device geometry data 102 (in mesh format) and compute gradient (loss) associated with the two meshes, it determines how the mesh for the device geometry data 102 is to be distorted to result in the point cloud. The computed gradient (loss) is input to the gradient module 260. The gradient module 260 also receives the updated device geometry data 104′ that has been generated by the BEM module 112 of FIGS. 1 and 2A. The gradient module 260 computes the gradient associated with the differences between output of the mesh loss computation module 270 and the updated device geometry data 104′ in order to determine the manner by which the parameters determining the device geometry data 102 need to be updated. In one nonlimiting example, a regularization module may be added to the output of the gradient module 260 (not shown here). It is appreciated that in some alternative embodiments, the mesh for the device geometry data 102 is sampled instead of sampling the mesh generated by the mesh generator module 240, or both meshes may be sampled for the loss computation.

Accordingly, the gradient of the system to the model data 262 is computed and output by the gradient module 260. It is appreciated that the model data refers to the data 242 that was received by the mesh generator module 240. The gradient of the system to the model data 262 is input to the mesh generator module 240 to compute the updated mesh. The updated model parameter/updated mesh data 244 may be output from the mesh generator module 240.

It is appreciated that the embodiment of FIG. 2B is configured to compute the derivatives/gradient similar to that described in FIG. 1 except that the derivatives are computed for the parameters of the received data 242 instead of the mesh vertices of FIG. 1. In other words, the embodiment described in FIG. 2B results in a more practical manufacturability optimization because the number of parameters that are updated or controlled can be changed (e.g., reduced) instead of updating the entire mesh associated with the device shape.

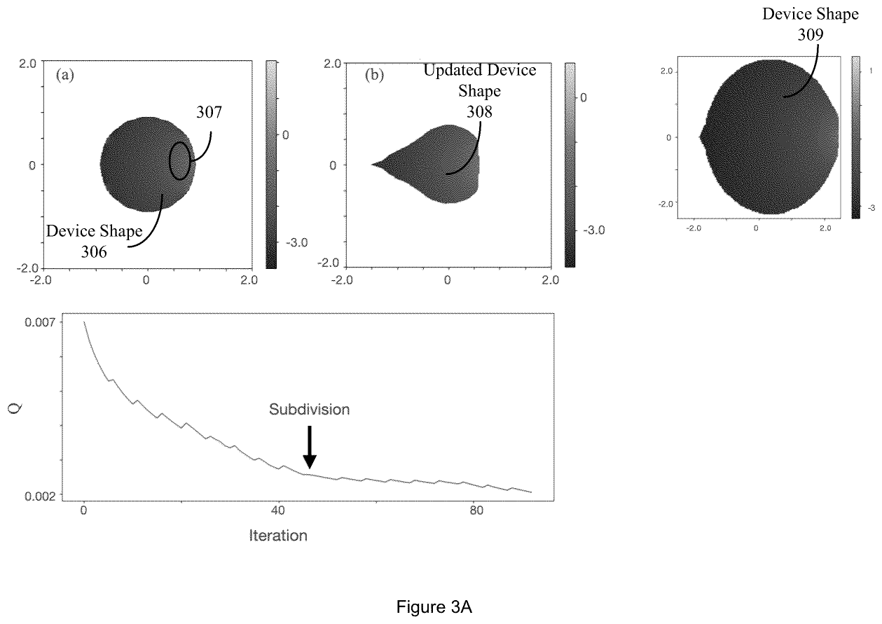

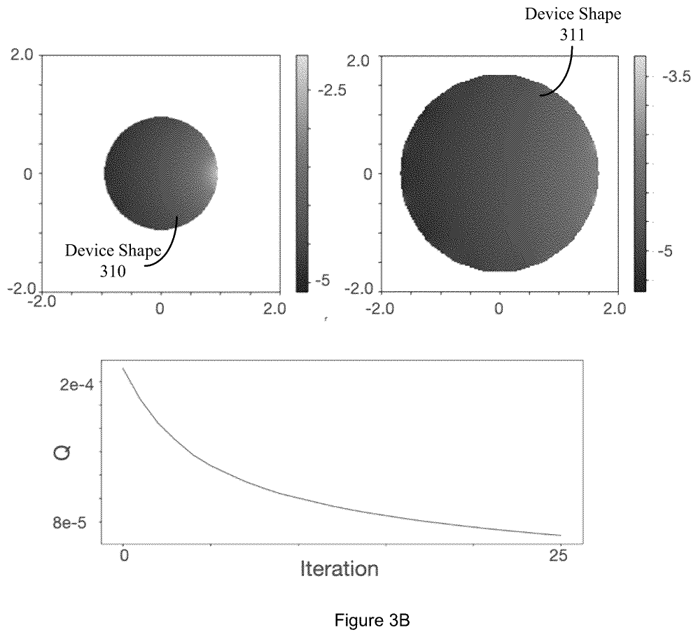

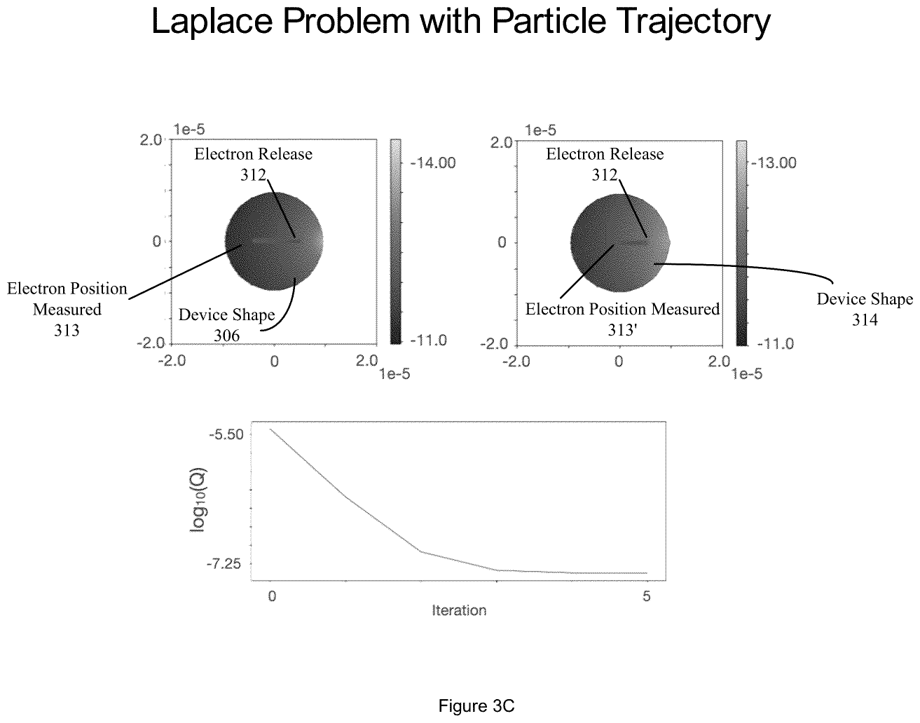

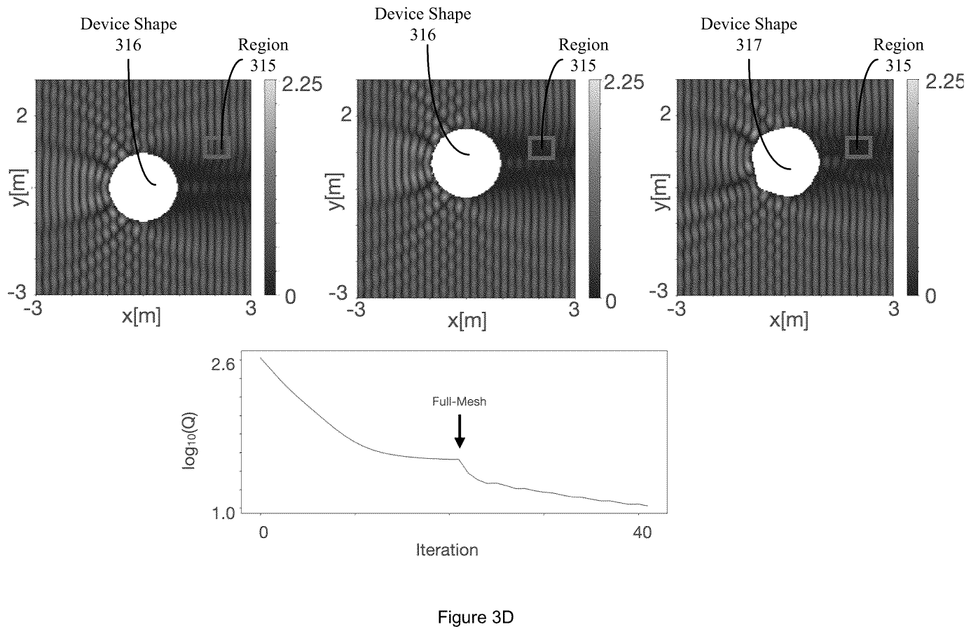

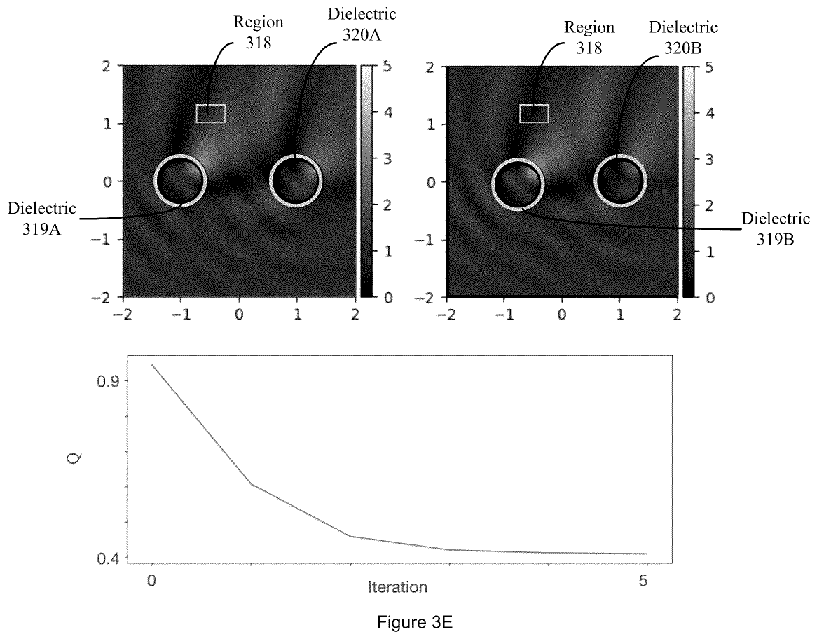

Referring now to FIG. 3A, an example to optimize device shape with reduced electrostatic field in the center of the device shape 306, e.g., a sphere, is shown for illustrative purposes. In this example, the user may desire the electrostatic field in the center to be reduced, e.g., 0. In this example, the embodiment as described in FIGS. 1 and 2A are used to reduce the electrostatic field in the center of the device shape 306. In this example, the voltage distribution is applied to the device shape 306, causing it to peak in region 307. The device shape 306 in this nonlimiting example is defined by 492 design parameters. The system of FIGS. 1 and 2A solve an interior Laplace problem and after several iterations results in the updated device shape 308. As illustrated, the updated device shape 308 results in the field being pushed out and elongated, therefore lowering the voltage at the center. In this nonlimiting example, the electrostatic field has been reduced by more than 3.5 times in 96 iterations. It is appreciated that a mesh smoothing operation has been applied. For comparison purposes, the device shape 309 after 6 iterations without a smoothing operation is shown for illustrative purposes. As illustrated, local distortions in the device shape 309 may neither be physical nor practical to manufacture. The mesh smoothing operation ensures a stable result with quick convergence for the BEM module 112. It is appreciated that the convergence of the system to an optimized device shape is also illustrated which is much more efficient and effective in comparison to the conventional method of changing the device shape manually, performing a simulation to measure the performance, and repeating the process a number of times to find an optimized device shape, if at all possible.

Referring now to FIG. 3B, a similar embodiment as FIG. 3A is shown except that instead of a full mesh update, the device shape 310 is optimized based on one or more device shape parameters, e.g., radius, in this example, as described in FIG. 2B. As illustrated, the device shape is successfully updated to device shape 311 based on changing one parameter, e.g., radius, instead of the full mesh while it has been able to reduce the electrostatic field.

Referring now to FIG. 3C, illustrates device shape optimization, as described in FIGS. 1-2B, for charged particle according to some embodiments. The device shape 306 in this nonlimiting example is the same as that described in FIG. 3A. In this example, a combination of electrostatic (as described in FIGS. 3A and 3B) and a subsequent computation for electron trajectory is used to illustrate the embodiments of FIGS. 1-2B. It is appreciated that the Verlet integration, as described above, may be used and the desired performance/performance measurement may be defined as the difference between the center of the device shape, e.g., sphere in this example, and the position of the electron after 20 ms. It is appreciated that the desired performance may be to decrease the acceleration of the electron due to the electrostatic filed. Prior to optimizing the device shape 306, the electron is released at position 312 and measured at position 313 (after 20 ms). In this nonlimiting example, using the embodiments of FIGS. 1-2B results in the updated device shape 314, in only a few iterations. For the updated device shape 314, the electron is released at position 312, however, as illustrated the electron travels less distance to the electron position measured 313′, thereby decreasing its acceleration due to the electrostatic field.

Referring now to FIG. 3D, another example is shown to illustrate the efficacy of the embodiments described in FIGS. 1-2B for a different application, e.g., Helmholtz as the underlying physics equation. It is appreciated that a solid object may scatter wave and, in this illustration, the desired shape of the object creates a shadow in region 315, thereby reducing the field. In this example, without any optimization and for illustration purposes, a wave number of 15 is travelling in the x-direction which is then scattered by the device shape 316. In this example and for illustration purposes, the device shape 316 is first optimized based on the embodiment of FIG. 2B, thereby moved along the y-axis first and in the subsequent step, the device shape is optimized using a full mesh methodology as described in FIGS. 1 and 2A to further optimize the device shape 316 to device shape 317. As illustrated the reduction in the amount of waves is more than 2.4 times.

Referring now to FIG. 3E, another example is shown to illustrate the efficacy of the embodiments described in FIGS. 1-2B for a different application, e.g., radar system using Maxwell equations as the underlying physics equation. In this example, the desired performance is to reduce the electromagnetic wave resembling a radar system (frequency of 300 Mhz) that is incident with an angle of 45 degrees in the x-y plane within region 318. In this nonlimiting example, the wave interacts with two spherical dielectrics 319A and 320A with dielectric constant of 2.1. In this example, optimization based on FIG. 2B (parameter optimizing allowing movement in the x-y direction) illustrates that moving the dielectrics 319A and 320A to their new location represented as dielectrics 319B and 320B reduces the intensity of the incoming wave in region 318. As illustrated, the radar intensity is reduced by a factor of more than 2 within the region 318. It is appreciated that the device shape is optimized only after a few iterations, e.g., 3-5.

It is appreciated that the embodiments as described in FIGS. 1-2B may similarly be used for other types of applications with other types of underlying physics equations. For example, the embodiments may be used for trapped ion quantum computing hardware.

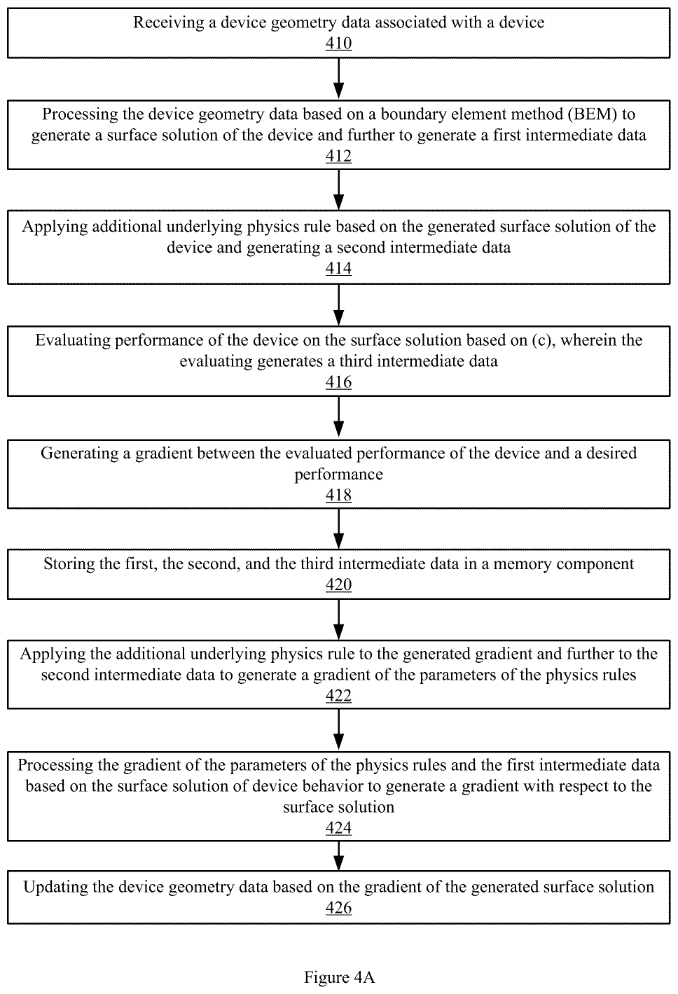

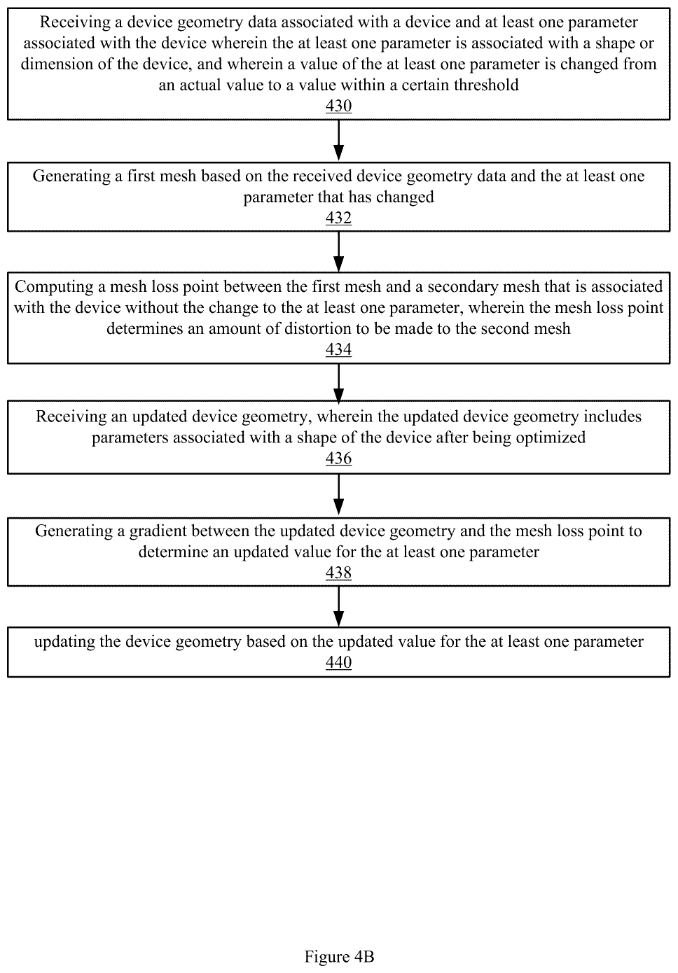

FIG. 4A is a flow chart illustrating an example method flow for optimizing a device shape (mesh vertices), as described in FIGS. 1-2A, in accordance with some embodiments. At step 410 a device geometry data associated with a device is received. At step 412, the device geometry data is processed based on a boundary element method (BEM) to generate a surface solution of the device and further to generate a first intermediate data. At step 414, additional underlying physics rule is applied based on the generated surface solution of the device and a second intermediate data is generated. At step 416, performance of the device is evaluated based on step 414 and a third intermediate data is generated. At step 418, a gradient between the evaluated performance of the device and a desired performance is generated. At step 420, the first, the second, and the third intermediate data are stored in a memory component. At step 422, the additional underlying physics rule is applied to the generated gradient and further to the second intermediate data to generate a gradient of the parameters of the physics rules. At step 424, the gradient of the parameters of the physics rules is processed based on the BEM and further based on the first intermediate data to generate a gradient of the generated surface solution. At step 426, the device geometry data is updated based on the gradient of the generated surface solution. It is appreciated that the steps 410-426, as described above, may be repeated a number of iterations. In some embodiments, a mesh smoothing operation may be added after a predetermined number of iterations, e.g., 1 iteration, 2 iterations, etc.

FIG. 4B is a flow chart illustrating an example method flow for optimizing a device shape one or more device shape parameters, as described in FIG. 2B, in accordance with some embodiments. At step 430, a device geometry data associated with a device and at least one parameter associated with the device are received, wherein the at least one parameter is associated with a shape or dimension of the device, and wherein a value of the at least one parameter is changed from an actual value to a value within a certain threshold, e.g., very small change. At step 432, a first mesh is generated based on the received device geometry data and the at least one parameter that has changed. At step 434, a mesh loss point between the first mesh and a secondary mesh that is associated with the device without the change to the at least one parameter is computed, wherein the mesh loss point determines an amount of distortion to be made to the second mesh. At step 436, an updated device geometry is received, e.g., updated device geometry data 104′ in a mesh format, where the updated device geometry includes parameters associated with a shape of the device after device shape optimization. At step 438, a gradient between the updated device geometry and the mesh loss point is generated to determine the updated value for the at least one parameter. At step 440, the device geometry is updated based on the updated value for the at least one parameter. It is appreciated that the steps 430-440 may be repeated a number of times (iterations). It is appreciated that the first mesh and/or the second mesh may be sampled prior to step 434.

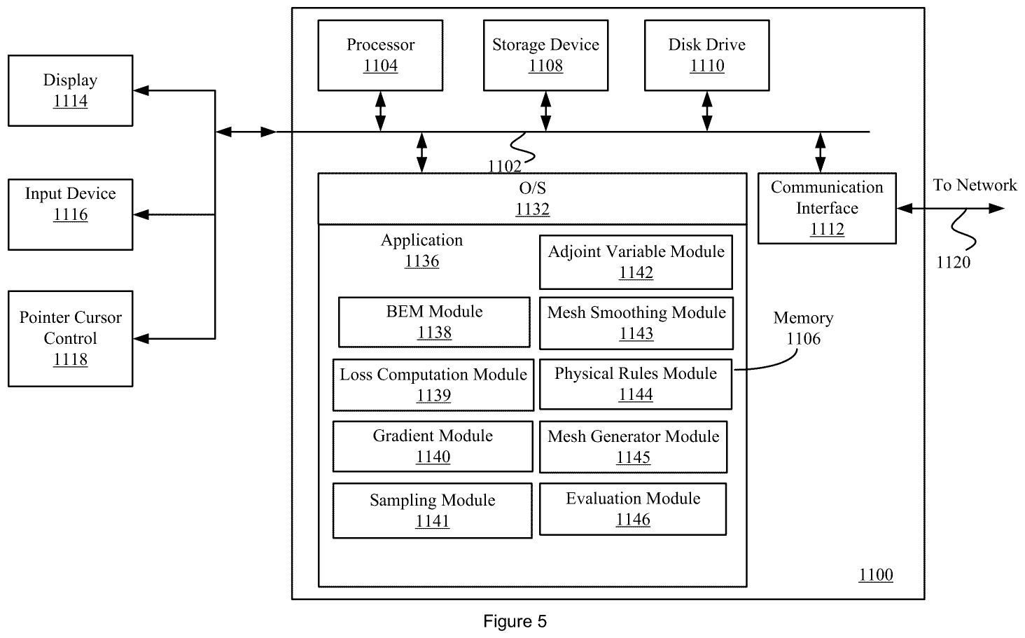

Referring now to FIG. 5, a block diagram depicting an example of computer system suitable for optimizing a device shape according to some embodiments is shown. In some examples, computer system 1100 can be used to implement computer programs, applications, methods, processes, or other software to perform the above-described techniques and to realize the structures described herein. Computer system 1100 includes a bus 1102 or other communication mechanism for communicating information, which interconnects subsystems and devices, such as a processor 1104, a system memory (“memory”) 1106, a storage device 1108 (e.g., ROM), a disk drive 1110 (e.g., magnetic or optical), a communication interface 1112 (e.g., modem or Ethernet card), a display 1114 (e.g., CRT or LCD), an input device 1116 (e.g., keyboard), and a pointer cursor control 1118 (e.g., mouse or trackball). In one embodiment, pointer cursor control 1118 invokes one or more commands that, at least in part, modify the rules stored, for example in memory 1106, to define the electronic message preview process.

According to some examples, computer system 1100 performs specific operations in which processor 1104 executes one or more sequences of one or more instructions stored in system memory 1106. Such instructions can be read into system memory 1106 from another computer readable medium, such as storage device 1108 or disk drive 1110. In some examples, hard-wired circuitry can be used in place of or in combination with software instructions for implementation. In the example shown, system memory 1106 includes modules of executable instructions for implementing an operation system (“O/S”) 1132, an application 1136 (e.g., a host, server, web services-based, distributed (i.e., enterprise) application programming interface (“API”), program, procedure or others). Further, application 1136 includes various modules that are described in detail with respect to FIGS. 1-2B. In some embodiments, the application 1136 includes a BEM module 1138, loss computation module 1139, gradient module 1140, sampling module 1141, adjoint variable module 1142, mesh smoothing module 1143, physical rules module 1144, mesh generator module 1145, and evaluation module 1146.

The term “computer readable medium” refers, at least in one embodiment, to any medium that participates in providing instructions to processor 1104 for execution. Such a medium can take many forms, including but not limited to, non-volatile media, volatile media, and transmission media. Non-volatile media includes, for example, optical or magnetic disks, such as disk drive 1110. Volatile media includes dynamic memory, such as system memory 1106. Transmission media includes coaxial cables, copper wire, and fiber optics, including wires that comprise bus 1102. Transmission media can also take the form of acoustic or light waves, such as those generated during radio wave and infrared data communications.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, electromagnetic waveforms, or any other medium from which a computer can read.

In some examples, execution of the sequences of instructions can be performed by a single computer system 1100. According to some examples, two or more computer systems 1100 coupled by communication link 1120 (e.g., LAN, PSTN, or wireless network) can perform the sequence of instructions in coordination with one another. Computer system 1100 can transmit and receive messages, data, and instructions, including program code (i.e., application code) through communication link 1120 and communication interface 1112. Received program code can be executed by processor 1104 as it is received, and/or stored in disk drive 1110, or other non-volatile storage for later execution. In one embodiment, system 1100 is implemented as a hand-held device. But in other embodiments, system 1100 can be implemented as a personal computer (i.e., a desktop computer) or any other computing device. In at least one embodiment, any of the above-described delivery systems can be implemented as a single system 1100 or can implemented in a distributed architecture including multiple systems 1100.

In other examples, the systems, as described above, can be implemented from a personal computer, a computing device, a mobile device, a mobile telephone, a facsimile device, a personal digital assistant (“PDA”) or other electronic device.

In at least some of the embodiments, the structures and/or functions of any of the above-described interfaces and panels can be implemented in software, hardware, firmware, circuitry, or a combination thereof. Note that the structures and constituent elements shown throughout, as well as their functionality, can be aggregated with one or more other structures or elements.

Alternatively, the elements and their functionality can be subdivided into constituent sub-elements, if any. As software, the above-described techniques can be implemented using various types of programming or formatting languages, frameworks, syntax, applications, protocols, objects, or techniques, including C, Objective C, C++, C #, Flex™, Fireworks®, Java™, Javascript™, AJAX, COBOL, Fortran, ADA, XML, HTML, DHTML, XHTML, HTTP, XMPP, and others. These can be varied and are not limited to the examples or descriptions provided.

While the embodiments have been described and/or illustrated by means of particular examples, and while these embodiments and/or examples have been described in considerable detail, it is not the intention of the Applicants to restrict or in any way limit the scope of the embodiments to such detail. Additional adaptations and/or modifications of the embodiments may readily appear to persons having ordinary skill in the art to which the embodiments pertain, and, in its broader aspects, the embodiments may encompass these adaptations and/or modifications. Accordingly, departures may be made from the foregoing embodiments and/or examples without departing from the scope of the concepts described herein. The implementations described above and other implementations are within the scope of the following claims.

What is claimed is:

1. A computer implemented method comprising:
a) receiving a device geometry data associated with a device;
b) processing the device geometry data based on a boundary element method (BEM) to generate a surface solution of the device behavior and further to generate a first intermediate data;
c) applying additional underlying physics rule based on the generated surface solution of the device behavior and generating a second intermediate data;
d) evaluating performance of the device based on (c), wherein the evaluating generates a third intermediate data;
e) generating a gradient between the evaluated performance of the device and a desired performance;
f) storing the first, the second, and the third intermediate data in a memory component;
g) applying the additional underlying physics rule to the generated gradient and further to the second intermediate data to generate a gradient of the parameters of the physics rules;
h) processing the gradient of the parameters of the physics rules and the first intermediate data based on the surface solution of device behavior to generate a gradient with respect to the surface solution; and
i) updating the device geometry data based on the gradient of the generated surface solution.

2. The computer implemented method of claim 1 further comprising repeating steps (a)-(i) for a number of iterations.

3. The computer implemented method of claim 2 further comprising applying a mesh smoothing operation subsequent to performing (i) and after a predetermined number of iterations.

4. The computer implemented method of claim 1, wherein the additional underlying physics rule is a Verlet integration for charged particles.

5. The computer implemented method of claim 1, wherein the additional underlying physics rule is received from a user.

6. The computer implemented method of claim 1, wherein at least one of the desired performance or the device geometry data is received from a user.

7. The computer implemented method of claim 1, wherein the BEM processes a partial differential equation of a Laplace type or a Maxwell equation or Helmholtz equation.

8. The computer implemented method of claim 1, wherein the device geometry data describes a shape associated with the device.

9. The computer implemented method of claim 1, wherein the device geometry data is in a triangular mesh format.

10. A computer implemented method comprising:
a) receiving a device geometry data associated with a device and at least one parameter associated with the device, wherein the at least one parameter is associated with a shape or dimension of the device, and wherein a value of the at least one parameter is changed from an actual value to a value within a certain threshold;
b) generating a first mesh based on the received device geometry data and the at least one parameter that has changed;
c) computing a mesh loss point between the first mesh and a secondary mesh that is associated with the device without the change to the at least one parameter, wherein the mesh loss point determines an amount of distortion to be made to the second mesh;
d) receiving an updated device geometry, wherein the updated device geometry includes parameters associated with a shape of the device after being optimized;
e) generating a gradient between the updated device geometry and the mesh loss point to determine an updated value for the at least one parameter; and
f) updating the device geometry based on the updated value for the at least one parameter.

11. The computer implemented method of claim 10 further comprising sampling the first mesh prior to the generating in (c).

12. The computer implemented method of claim 10 further comprising sampling the second mesh prior to the generating in (c).

13. The computer implemented method of claim 10, wherein the at least one parameter includes one or more of a radius, length, width, and height.

14. The computer implemented method of claim 10, wherein device geometry data is received from a user.

15. The computer implemented method of claim 10, wherein the device geometry data describes a shape associated with the device.

16. The computer implemented method of claim 10, wherein the device geometry data is in a triangular mesh format.

17. The computer implemented method of claim 10 further comprising repeating steps (a)-(f) for a number of iterations.

18. A system comprising:
a processor configured to process data; and
a memory component configured to store one or more data;
wherein the processor comprises:
a boundary element method (BEM) module configured to receive a device geometry data associated with a device and process the device geometry data to generate a surface solution of device behavior, wherein the BEM module is further configured to generate a first intermediate data;
a physics rules module configured to apply additional underlying physics rule based on the generated surface solution of the device, wherein the physics module is further configured to generate a second intermediate data; and
evaluation module configured to evaluate performance of the device based on an output from the physics rule module, wherein the evaluation module is further configured to generate a third intermediate data,
wherein the first, the second, and the third intermediate data are stored in the memory component,
wherein result generated by the evaluation module is input to the physics rules module, and wherein the physics rules module further receives the second intermediate data from the memory component and generates a gradient of the parameters based on the additional underlying physics rules,
wherein the gradient of the parameters generated by the physics rules module is input to the BEM module, and wherein the BEM module is further configured to receive the first intermediate data from the memory component, wherein the BEM is configured to generate an updated device geometry data based on the gradient of the parameters and further based on the first intermediate data.

19. The system of claim 18 further comprising a mesh processing module configured to smooth a mesh associated with the updated device geometry data.

20. The system of claim 18, wherein the additional underlying physics rule is one of a Verlet integration for charged particles.

21. The system of claim 18, wherein the additional underlying physics rule or the desired performance or the device geometry data is received from a user.

22. The system of claim 18, wherein the device geometry data describes a shape associated with the device.

23. The system of claim 18, wherein the device geometry data is in a triangular mesh format.

24. The system of claim 18, wherein the BEM module is configured to process a partial differential equation of a Laplace type or a Maxwell equation or Helmholtz equation.
